(19) United States
(12) Patent Application Publication
(10) Pub. No.: US 2003/0084407 A1
(43) Pub. Date: May 1, 2003

(54) Document display method and apparatus

(76) Inventors: Seiji Tanaka, Nagano-ken (JP); Takuya Suetani, Tokyo (JP); Kiyoshi Ogawa, Tokyo (JP); Hiroshi Ono, Tokyo (JP)

Correspondence Address: HOGAN & HARTSON L.L.P., 500 S. GRAND AVENUE, SUITE 1900, LOS ANGELES, CA, 90071-2611, US

(21) Appl. No.: 10/226,088

(22) Filed: Aug. 21, 2002

(30) Foreign Application Priority Data
Aug. 27, 2001 (JP) 2001-256334

(51) Int. Cl. G06F 15/00

(52) U.S. Cl. 715/529

(57) ABSTRACT

There is provided a provide a document display method and apparatus that makes it possible to grasp an object to be subjected to character decoration or layout of characters, when a document subjected to character decoration is displayed, even with a small-sized display screen. A synthesis character is made available which is formed by synthesizing a character decoration start mark indicative of a character decoration starting end as a starting end or a changing end of character decoration set to a portion of the document, and a decoration start character which is a character at the character decoration starting end of the portion to which the character decoration is set. The synthesis character is displayed in place of two characters of the character decoration start mark and the decoration start character, when the at least part of the document includes the decoration start character.

### BACKGROUND OF THE INVENTION

1. Field of the Invention

This invention relates to a document display method and apparatus.

2. Prior Art

In a document processing apparatus, such as a personal computer (PC) having word processor software installed thereon or a word processor as a dedicated machine for word processing, it is possible to input and edit a document by using a relatively large display screen (edit screen). In contrast, a relatively small-sized document processing apparatus, such as a desk-top tape printing apparatus or a stamp making apparatus, has only a relatively small-sized display screen, and therefore, when a plurality of lines of a document are to be displayed, only limited part thereof can be displayed at a time. Further, in this case, to enable the user to easily grasp the position or the like of the displayed part with respect to the whole document, a predetermined symbol (line mark), for example, which corresponds to one character and represents information of a division of lines or a line number, is displayed together with a character string of each line. Further, to indicate portions of lines, which are subjected to character decoration, various methods have been proposed. For example, a pair of predetermined symbols (character decoration marks) each corresponding to one character are used to sandwich a character string to be decorated, therebetween, for display, or a starting end or a changing end of a range of character decoration is indicated by one of various character decoration marks.

For example, assuming that e.g. a circled number 2 is added to the head of a second line as a mark indicative of the second line, and “ [symbol] ” (shown as a black-filled right-oriented triangle in the figure) is used as the predetermined character decoration mark, if character decoration is applied to “ [symbol] ” of the second line “ [symbol] [symbol] ” by using a display screen capable of displaying a total of six characters (line mark+five characters) as shown in FIG. 15A, the displayed result is “\mathring{2} [symbol] [symbol] ” as shown in FIG. 16A. Other methods than this are also possible. For example, a different symbol (character decoration mark) may be added e.g. by using “<” (shown as a black-filled left-oriented triangle in the figure) to indicate the terminating end of the range of the character decoration, thereby displaying “\mathring{2} [symbol] [symbol] ”, or on condition that the same character decoration is applied up to the tail end of a line, a character decoration mark indicative of the terminating end is omitted, thereby displaying “\mathring{2} [symbol] [symbol] ”.

In the case of the above character decoration being so-called reversal of characters (reversed characters), if this decoration is not applied, the character string is printed as shown in FIG. 15B, whereas if the character decoration is applied, the same is printed as shown in FIG. 16B. In this case, the second line subjected to the character decoration is printed in alignment with the other lines. On the other hand, when the character strings are displayed, as shown in FIGS. 15A and 16A, due to the existence of the character decoration marks, the second line subjected to character decoration is displayed in a manner displaced from the other lines. This makes it difficult to grasp an image of layout of characters as an actual result of edit (to be reflected on the print), from the displayed image at the time of edit.

### SUMMARY OF THE INVENTION

It is an object of the invention to provide a document display method and apparatus that makes it possible to grasp an object subjected to character decoration or layout of characters, when a document subjected to character decoration is displayed, even with a small-sized display screen.

To attain the above object, according to a first aspect of the invention, there is provided a document display method for displaying at least part of a document in which a plurality of characters are arranged,

the document display method comprising the step of:

making available a synthesis character formed by synthesizing a character decoration start mark indicative of a character decoration starting end as a starting end or a changing end of character decoration set to a portion of the document, and a decoration start character which is a character at the character decoration starting end of the portion to which the character decoration is set; and

displaying the synthesis character in place of two characters of the character decoration start mark and the decoration start character, when the at least part of the document includes the decoration start character.

To attain the above object, according to a second aspect of the invention, there is provided a document display apparatus for displaying at least part of a document in which a plurality of characters are arranged,

the document display apparatus comprising:

synthesis character-forming means for forming a synthesis character by synthesizing a character decoration start mark indicative of a character decoration starting end as a starting end or a changing end of character decoration set to a portion of the document, and a decoration start character which is a character at the character decoration starting end of the portion to which the character decoration is set; and

display means for displaying the synthesis character in place of two characters of the character decoration start mark and the decoration start character, when the at least part of the document includes the decoration start character.

To attain the above object, according to a third aspect of the invention, there is provided a document display apparatus for displaying at least part of a document in which a plurality of characters are arranged,

the document display apparatus comprising:

synthesis character-storing means for storing synthesis characters each formed by synthesizing a character decoration start mark indicative of a character decoration starting end as a starting end or a changing end of character decoration set to a portion of the document, and one of a plurality of characters each of which can be a decoration start character as a character at the character decoration starting end of the portion to which the character decoration is set; and

display means for displaying one of the synthesis characters in place of two characters of the character decoration start mark and the decoration start character, when the at least part of the document includes the decoration start character.

According to these document display method and apparatuses, in place of two characters of a character decoration start mark and a decoration start character, a synthesis character formed by synthesizing the character decoration mark and the decoration start mark is made available ((by newly forming the same or by selecting a corresponding one of synthesis characters prepared and stored in advance) for display. Therefore, the displayable range of the document can be increased even when the display screen having the same size as that of the prior art is used. Further, since there occurs no displacement of character arrangement which has been conventionally caused by provision of the character decoration start mark, it is easier for the user to grasp the position of each character.

To attain the above object, according to a fourth aspect of the invention, there is provided a document display method for displaying at least part of a document in which a plurality of characters are arranged, with a line mark added to each of at least one line formed by the plurality of characters,

the document display method comprising the steps of:

making available a synthesis line mark formed by synthesizing the line mark and a character decoration start mark indicative of a starting end of character decoration set to a portion of the document, when a character at the starting end of the character decoration is a start character at a start of one of the at least one line; and

displaying the synthesis line mark in place of the line mark, while omitting the character decoration start mark.

To attain the above object, according to a fifth aspect of the invention, there is provided a document display apparatus for displaying at least part of a document in which a plurality of characters are arranged, with a line mark added to each of at least one line formed by the plurality of characters,

the document display apparatus comprising:

synthesis line mark-forming means for forming a synthesis line mark by synthesizing the line mark and a character decoration start mark indicative of a starting end of character decoration set to a portion of the document, when a character at the starting end of the character decoration is a start character at a start of one of the at least one line; and

display means for displaying the synthesis line mark in place of the line mark, while omitting the character decoration start mark.

To attain the above object, according to a sixth aspect of the invention, there is provided a document display apparatus for displaying at least part of a document in which a plurality of characters are arranged, with a line mark added to each of at least one line formed by the plurality of characters,

the document display apparatus comprising:

decoration line mark-storing means for storing a decoration line mark corresponding to the line mark; and

display means for displaying the decoration line mark in place of the line mark, when a character at the starting end of character decoration set to a portion of the document is a start character at a start of one of the at least one line.

According to the document display method and apparatuses, when a character at the starting end of character decoration set to a portion of the document is a start character at a start of one of the at least one line, in place of a line mark, a decoration line mark corresponding to the line mark is arranged and displayed, without additionally displaying a character decoration start mark indicative of the starting end of character decoration. Therefore, the displayable range of the document can be increased even when the display screen having the same size as that of the prior art is used. Further, since there occurs no displacement of character arrangement which has been conventionally caused by additional provision of the character decoration start mark, it is easier for the user to grasp the position of each character.

For example, the at least one line is displayed in a line, and the line mark and the synthesis line mark each play a role of a mark indicative of a position where a new line is started.

It is preferred that the line mark and the synthesis line mark each represents a line number of the line associated therewith.

The above and other objects, features, and advantages of the invention will become more apparent from the following detailed description taken in conjunction with the accompanying drawings.

### BRIEF DESCRIPTION OF THE DRAWINGS

FIG. 1 is a perspective view of the appearance of a tape printing apparatus according to the invention;

FIG. 2 is a bottom view of the whole of the FIG. 1 tape printing apparatus with an apparatus casing thereof removed;

FIG. 3 is a cross-sectional view of the whole of the FIG. 1 tape printing apparatus;

FIG. 4 is a block diagram of a control system of the FIG. 1 tape printing apparatus;

FIGS. 5A to 5F are diagrams useful for explaining examples of a data structure of display data and a displayed state;

FIGS. 6A and 6B are diagrams useful for explaining a specification of setting values of typefaces and decorations which can be set to the whole document or on a line-by-line basis;

FIG. 7A is a diagram useful for explaining a specification of setting values of formats which can be set to the whole document;

FIG. 7B is a diagram useful for explaining a specification of setting values of styles which can be set to the whole document;

FIG. 8A is a diagram useful for explaining examples of display screen views when character decoration is not applied or the same character decoration is applied to the whole document, and operations therefor;

FIG. 8B is a diagram showing an example of printed results corresponding to the FIG. 8A case;

FIG. 9 is a diagram useful for explaining examples of display screen views, and operations therefor, when decoration is set in a setting mode;

FIG. 10 is a flowchart of a process for carrying out display of a display screen view after setting thereof is completed by the FIG. 9 operations;

FIG. 11A is a diagram useful for explaining examples of display screen views when character decoration is applied on a line-by-line basis, and operations therefor;

FIG. 11B is a diagram useful for explaining an example of printed results corresponding to the FIG. 11A case;

FIGS. 12A to 12F are diagrams useful for explaining examples of line marks prepared in a manner adapted to various kinds of character decoration;

FIGS. 13A to 13C are diagrams useful for explaining an example of display of a character decoration start mark combined with the following character;

FIGS. 14A to 14C are diagrams useful for explaining a conventional case corresponding to FIGS. 11A, 11B;

FIG. 15A is a diagram useful for explaining examples of display screen views when character decoration is not applied, and operations therefor;

FIG. 15B is a diagram showing an example of printed results corresponding to the FIG. 15A case; and

FIGS. 16A and 16B are diagrams similar to FIGS. 15A and 15B, which are useful for explaining examples of display screen views when character decoration is applied while displaying a plurality of lines, and at the same time a conventional display method is employed.

### DETAILED DESCRIPTION

The invention will now be described in detail with reference to the drawings showing a tape printing apparatus according to an embodiment thereof.

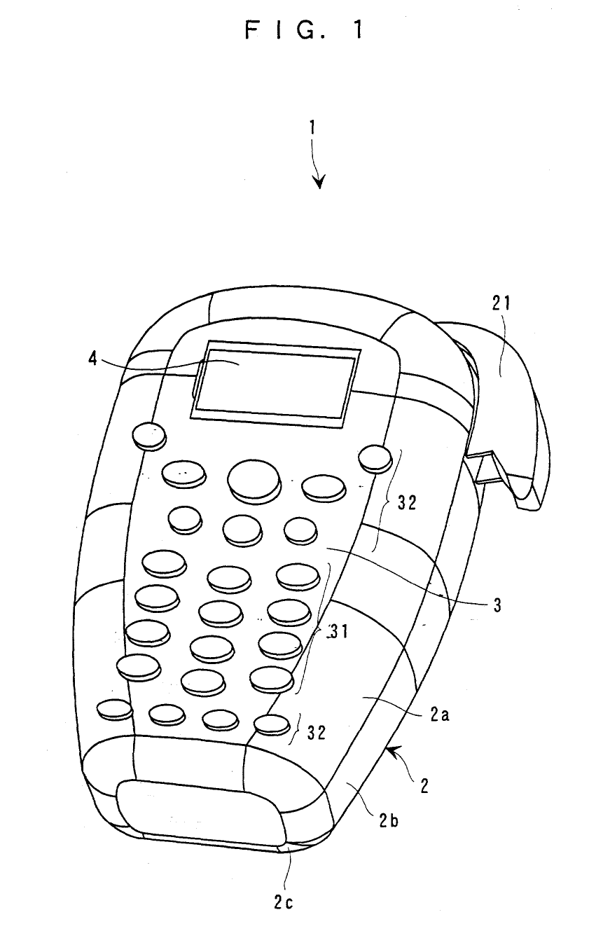

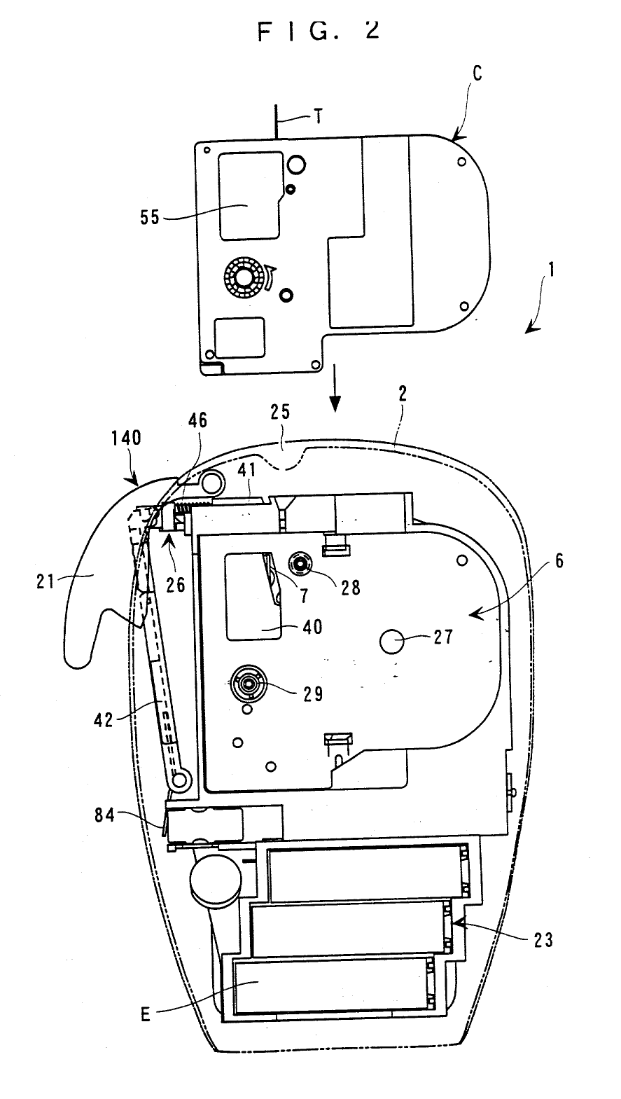

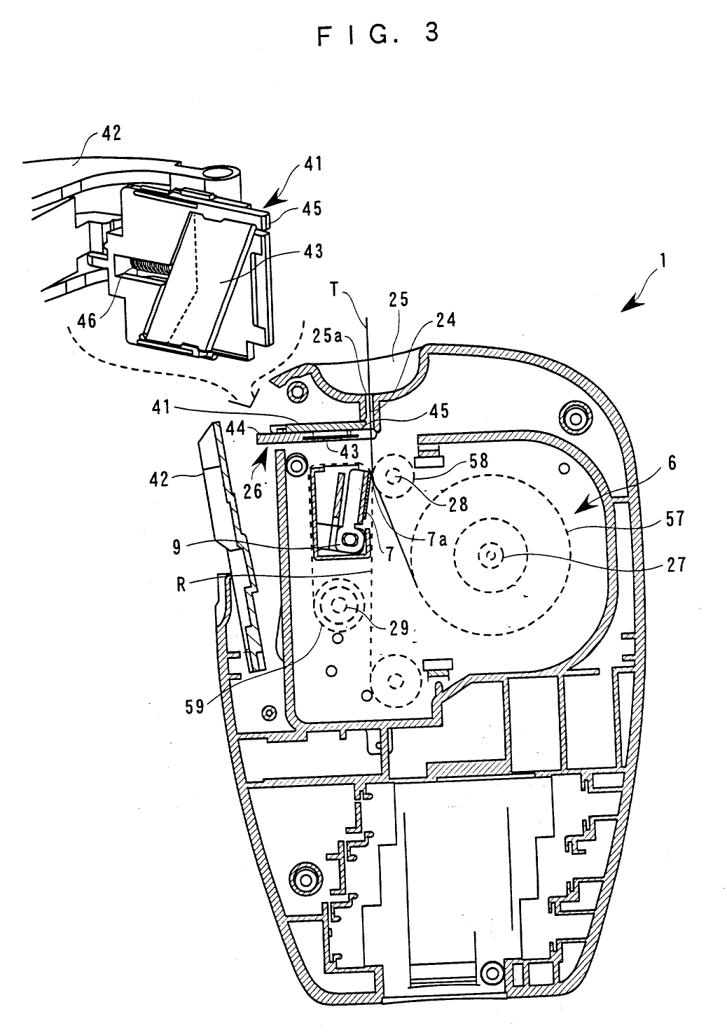

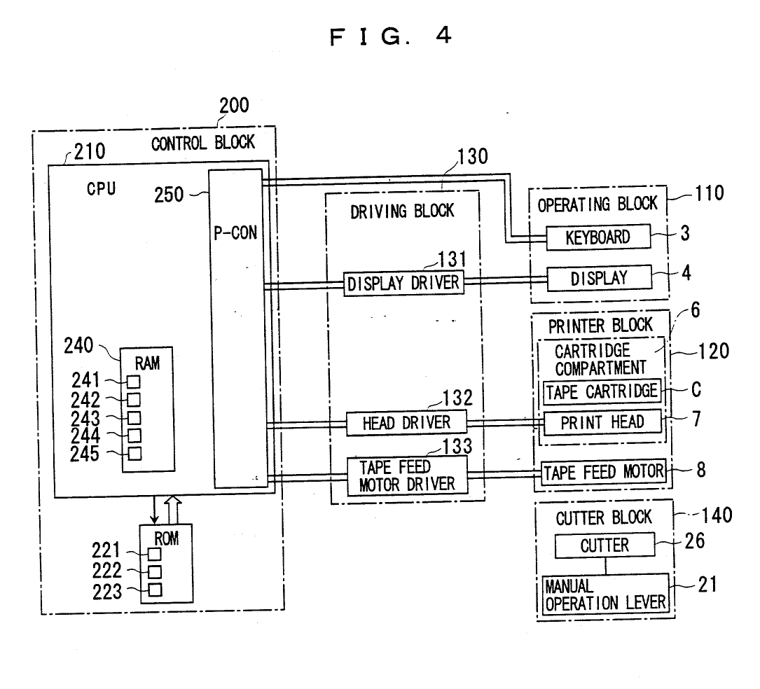

FIG. 1 is a perspective view of the whole appearance of the tape printing apparatus 1, while FIG. 2 is a bottom view of the whole of the same with its apparatus casing removed. Further, FIG. 3 shows the apparatus 1 in full cross-section, and FIG. 4 is a block diagram showing functional blocks of the FIG. 1 tape printing apparatus. The tape printing apparatus carries out printing of letters, symbols, figures, decorations, and so forth on the tape T based on print data entered by a user, while feeding the tape unwound from a tape cartridge removably loaded in the apparatus, and then cutting the printed portion of the tape to a tape length calculated based on the print data, to thereby produce a label.

As shown in FIGS. 1 to 3, the tape printing apparatus has a casing 2 forming an outer shell having a generally oval shape in plan view, a keyboard 3 arranged on a front top thereof and comprised of various input keys, and a display 4 arranged at a rear top thereof and comprised of an LCD. The casing 2 includes an upper casing 2a forming the top surface, a middle casing 2b welded to the upper casing 2a and positioned at an intermediate location, and a lower casing 2c forming the bottom thereof. The lower casing 2c is removable from the middle casing 2b. The tape cartridge C and a battery 8 are mounted in the apparatus casing 2 from below, and the tape cartridge C contains the tape T with a peel-off paper, on which printing is carried out, such that the tape T can be rolled out from the tape cartridge C. To the right-side rear portion of the apparatus casing 2 is attached a manual operation lever 21 projecting outward from the apparatus casing 2 and extending frontward along the right-side surface of the same. Further, inside the bottom of the casing 2, there are formed front, intermediate, and rear battery-receiving blocks 23 for receiving six batteries E in total such that the blocks 13 each containing two batteries are arranged in a staggered manner, and a cartridge compartment 6 at a rear-side location, for removably receiving the tape cartridge C therein.

As shown in FIG. 4, the tape printing apparatus is basically configured to include an operating block 110 that interfaces with the user via the keyboard 3 and the display 4, a printer block 120 that has a print head (thermal head) 7 and a tape feed motor 8 and carries out printing on the tape T wound from the tape cartridge C mounted in the cartridge compartment 6, a driving block 130 that has drivers and drives circuits, a cutter block 140 that cuts off the printed portion of the tape T, and a control block 200 for controlling these blocks. Therefore, the casing 2 contains not only the printer block 120, the cutter block 140, and so forth, but also a circuit board, not shown, on which the circuits of the driving block 130 and the control block 200 are mounted.

The printer block 120 is formed with the cartridge compartment 6 in which are erected a guide projection 27 for guiding the tape cartridge C when it is mounted in the cartridge compartment 6, a platen drive shaft 28 for giving a torque to driven portions of the tape cartridge C, a ribbon take-up shaft 29 and a head unit 9 including a print head 7 opposed to the platen drive shaft 28.

The tape cartridge C contains not only the tape T wound around a tape reel 57, but also an ink ribbon R to be fed, similarly to the tape T, in a longitudinal direction thereof with its width positioned vertically, and a platen 58 for engagement with the platen drive shaft 28. Further, formed in the vicinity of the platen 58 is a head opening 55 to which the print head 7 is brought. The ink ribbon R meets the tape T at a location (printing position 7a) where the platen 58 (print head 7) is arranged, and fed or run together with the tape T in a state lying upon the tape T, followed by being taken up by the ribbon take-up reel 59 with which the ribbon take-up shaft 29 is engaged. On the other hand, the tape T passes through a slit opening formed in a side portion of the casing of the tape cartridge C, and is sent out via the tape exit 25. It should be noted that tape cartridges C are provided which contain four kinds of tapes T having respective tape widths of 6 mm, 9 mm, 12 mm and 18 mm.

The cutter block 140 is comprised of the cutter 26 which can slide in a left-right direction as viewed in the figure to and from a position opposed to the tape exit 25, a tape-retaining member 41 positioned immediately behind the cutter 26 and slidable together with the same, the manual operation lever 21 for causing the cutter 26 to perform cutting operation, and a pivot arm 42 interposed between the manual operation lever 21 and the cutter 26. In the cutter block 140, the pivot arm 42 is pivoted by operation of the manual operation lever 21, and the pivotal motion of the pivot arm 42 causes the cutter 26 and the tape-retaining member 41 to slide, whereby the tape T is cut through by force-cutting by the cutter 26 in a state held by the tape-retaining member 41. When a pressing force is transmitted from the manual operation lever 21 via the pivot arm 42, the tape-retaining member 41 starts sliding forward (rightward as viewed in FIG. 3) together with the cutter 26.

The tape-retaining member 41 has a tape-retaining face portion 45 slightly protruding beyond the forward end of a cutter blade 43 of the cutter 26 in a sliding direction (i.e. in a cutting direction), and hence, when the cutter 26 and the tape-retaining member 41 slide forward, the tape-retaining member 41 advances ahead of the cutter blade 43 and comes into abutment against a stopper portion to press the tape T against the same. As a result, the motion of the tape-retaining member 41 is stopped, but the cutter 26 cuts into the tape T while compressing a spring 46. The cutter blade 43 progressively cuts into the tape T by force cutting vertically downwardly in the direction of width of the tape T to cut off the printed portion of the tape T. During the cutting operation by the cutter blade 43, the tape T is pressed firmly against the stopper portion at a location downstream in the feeding direction by the tape-retaining member 41 urged by the compressed spring 46, so that it is possible to cut the tape T stably. When the edge of the cutter blade 43 advances beyond the location of a passage slit 24 to cut off the printed portion of the tape T completely, the manual operation lever 21 is brought into a stopped state, whereby further cutting is inhibited.

When the user returns the manual operation lever 21 from this state, the cutter 26 shifts to a return operation prior to the tape-retaining member 41, in which the cutter 26 slides backward (leftward as viewed in FIG. 3) together with the tape-retaining member 41 by being driven by a rotational force of a coiled spring 84 attached to the base portion of the pivot arm 42, until a pair of guide pieces formed, respectively, on the top and bottom of the tape-retaining member 41 reach the ends of a pair of guide grooves formed in a cutter support frame 44 to stop the backward sliding of the cutter 26. The instant at which the tape-retaining member 41 leaves the tape T, the cut-off tape strip T (label) falls from the tape exit 25 due to its own weight. If the tape length t of the produced tape strip T is short (i.e. when the length of the portion of the tape T exposed from the exit position 25a is short) or if the user does not want to let the cut-off portion fall, it is preferred that the tape T is cut with its leading end held between the user's fingers, whereby the tape strip T (label) can be reliably discharged out of the apparatus 1 without letting it fall.

The driving block 130 has a display driver 131, a head driver 132, and a tape feed motor driver 133. The display driver 131 drives the display 4 of the operating block 110 according to instructions transmitted thereto by a control signal delivered from the control block 200. Similarly, the head driver 132 drives the print head 7 of the printer block 120 according to instructions transmitted thereto by a control signal delivered from the control block 200. Further, the tape feed motor driver 133 drives the tape feed motor 8 according to instructions transmitted thereto by a control signal delivered from the control block 200.

The operating block 110 has the keyboard 3 and the display. The display 4 has a display screen capable of displaying three characters. The display 4 is used when the user inputs data from the keyboard 3, and forms or edits print image data, such as character string data, and views the results of the forming and editing operation carried out on the print image data, or inputs commands or selecting instructions from the keyboard 3.

On the keyboard 3, there are arranged a character key group 31 including an alphabet key group, and a number key group, as well as a function key group 32 for designating various operation modes and for other purposes. In a type of the apparatus which is capable of inputting the Japanese language, the character key group 31 also includes a kana key group for inputting Japanese hiragana letters and Japanese katakana letters. The function key group 32 includes a power key, not shown, a print key for instructing the apparatus 1 to perform printing operation, and a selection key 323 for finally determining the entry of character data and starting a new line during text entry as well as determining selection of one of modes or options on a selection screen.

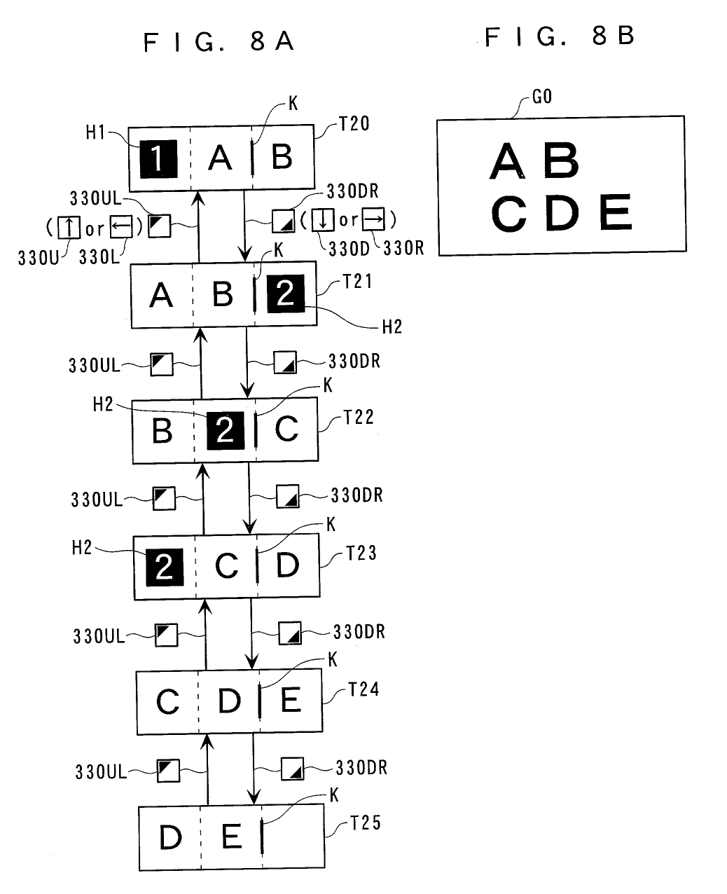

Further, the function key group 32 further includes a left arrow key 330L for moving the cursor leftward (“←”), an up arrow key 330U for moving the cursor upward (“↑”) (in the present embodiment, these keys effect the same results on the edit screen, and hence they are collectively indicated by 330UL, and shown in the figure by a box with a leftward-oriented black-filled triangle see FIG. 8), a right arrow cursor key 330R for moving the cursor rightward (“→”) and a down arrow key 330D (“↓”) for moving the cursor downward (in the present embodiment, these keys effect the same results on the edit screen, and hence they are collectively indicated by 330DR, and shown in the figure by a box with a rightward-oriented black-filled triangle see FIG. 8).

The function key group 32 further includes, a cancel key 326 for canceling various instructions, a mode key 329 for switching the mode of the apparatus to a setting mode for setting format/style/character decoration, and a file key for handling files. Of course, similarly to keyboards of the general type, the above-mentioned key entries may be made by the respective keys exclusively provided therefor or by a smaller number of keys operated in combination with the shift key and/or the like. Here, for purposes of ease of understanding, the following description will be made assuming that there are provided as many keys as described above. As shown in FIG. 1, from the keyboard 3, various commands described above and data are input to the control block 200.

The control block 200 includes a CPU 210 incorporating a RAM 240 and a peripheral control circuit (P-CON), and a ROM 220, both of which are internally connected to each other. The ROM 220 has not only a control program area 221 storing control programs executed by the CPU 210, but also a control data area 222 storing control data including a color conversion table, a character modification table, and the like, and a character generator ROM (CG-ROM) area 223 storing font data, i.e. data defining characters, symbols, figures and the like, provided for the tape printing apparatus 1. When code data specifying a character or the like is input to the CG-ROM area 223, it outputs the corresponding font data.

The RAM 240 is supplied with power by a backup circuit, not shown, such that stored data items can be preserved even when the power is turned off. The RAM 240 includes areas of a register group 241, a text data area 242 for storing text data of characters or the like entered by the user via the keyboard 3, a display image data area 243 for storing image data displayed on the display 4, a print image data area 244 for storing print image data, and buffer areas 245 including a print buffer. The RAM 240 is used as a work area for carrying out control operations. The P-CON 250 incorporates a logic circuit for handling interface signals for interfacing between the CPU 210 and peripheral circuits. The P-CON 250 is connected to the keyboard 3, for receiving commands and data entered via the keyboard 3, directly or after processing them, and outputs data and control signals to the driving block 130 directly or after processing them.

The CPU 210 receives commands, data, and the like via the P-CON 250 according to the control program read from the ROM 220, processes front data from the CG-ROM 230, various data stored in the RAM 240, and so forth, and delivers control signals to the driving block 130 via the P-CON 250 to thereby control the operations of the tape feed motor 8 and the display 4, as well as to control the print head 7 to perform printing on the tape A under predetermined printing conditions. In short, the CPU 210 controls the overall operation of the tape printing apparatus 1.

The tape printing apparatus 1 constructed as above is formed to have a predetermined thickness as a whole, and to be small enough to carry easily with one hand. When the apparatus 1 is in actual use, the user holds the main unit in both hands and operates keys of the keyboard 3 by using the thumbs or other fingers of his/her hands to enter desired letters or the like. Further, when it is required to cut off a printed portion of the tape T after completion of printing, the manual operation lever 21 of the main unit held in the hands is pivoted inward toward the user by his/her right index or middle finger.

To use the tape printing apparatus 1, first, the user turns the main unit upside down and removes the lower casing 2c, and then mounts the tape cartridge C in the cartridge compartment 6. When the tape cartridge C is mounted in the cartridge compartment 6, the leading end portion of the tape T and the ink ribbon R are inserted between the platen 58 and the print head 7, and the platen 58 and the ribbon take-up reel 39 are brought into engagement with the platen drive shaft 28 and the ribbon take-up shaft 29, respectively. Then, when the lower casing 2c is mounted to the middle casing 2b, the print head 7 pivotally moves and abuts on the platen 58 to sandwich the tape T and the ink ribbon R between the platen 58 and the print head 7 itself, and the apparatus 1 is placed in a printing wait state.

Then, the user turns over the main unit to its normal position, and prepares for entry while holding the main unit with both hands. When the preparation is made, the user depresses the power key to turn on the apparatus 1, and then enters information of the type of the tape cartridge C by operating the keyboard 3 while viewing the display 4. After the type of the tape cartridge C is recognized, the user operates the keyboard 3 to enter/edit desired characters and issue an instruction for printing.

When the instruction for printing is issued, the tape T and the ink ribbon R are fed simultaneously, and the print head 7 is driven for heating as required, whereby ink of the ink ribbon R is thermally transferred onto the tape T. The portion of the ink ribbon R used for printing is taken up within the tape cartridge C, whereas the printed portion of the tape T is sent out via the tape exit 25 (exit position 25a). The printed portion of the tape T is cut off when the manual operation lever 21 is operated by the user after feeding of the tape T is stopped. More specifically, the tape-retaining member 41 slides to the stopper portion to sandwich the tape T between the stopper portion and the tape-retaining member 41 itself, and then the printed portion of the tape T is cut off by the cutter 26 which has slid after the tape-retaining member 41.

As described above, the tape printing apparatus 1 according to the present embodiment is a portable tape printing apparatus, and the display 4 has only a small-sized display screen (capable of displaying only three characters). However, it employs a document processing method which enables the user to grasp an object to be subjected to character decoration and a kind of the character decoration, and therefore, detailed description of this method will be given hereafter.

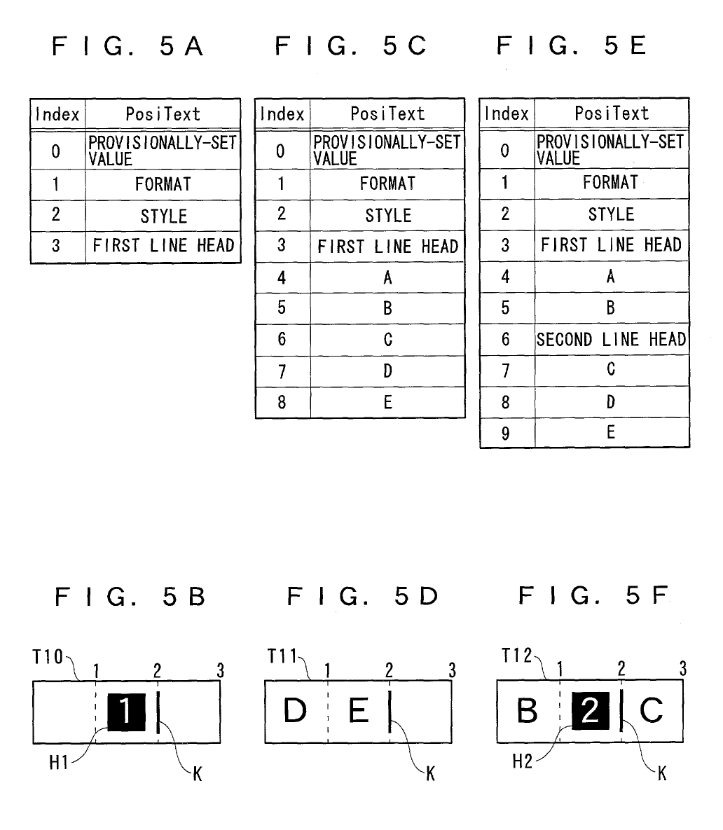

First, text data to be displayed and edited (format thereof, i.e. so-called data structure) is as shown in FIG. 5A, and on the display 4, the data is displayed as shown in FIG. 5B (screen T10, hereinafter, contents displayed on the display screen 4 are referred to as “screen Txx” (x represents a digit) and shown in figures with the same reference numeral. Further, the position of the cursor is indicated by K in the figure.) However, the cursor K of the present embodiment is displayed in a state fixed to a right side of a second character within the display screen, and characters to be edited are moved relative to the cursor K whereby the cursor K plays the role of the cursor. The value of Index=0 in FIG. 5A (hereinafter referred to as “In[0]”, which rule is also applies to other indexes.) represents a provisionally-set value (hereinafter referred to as “In[0]=“provisional”). Similarly, the other index values mean In [1]=“format”, In [2]=“style”, and In [3]=“head of a first line”, and each represented by a numerical value of two bytes (16 bits).

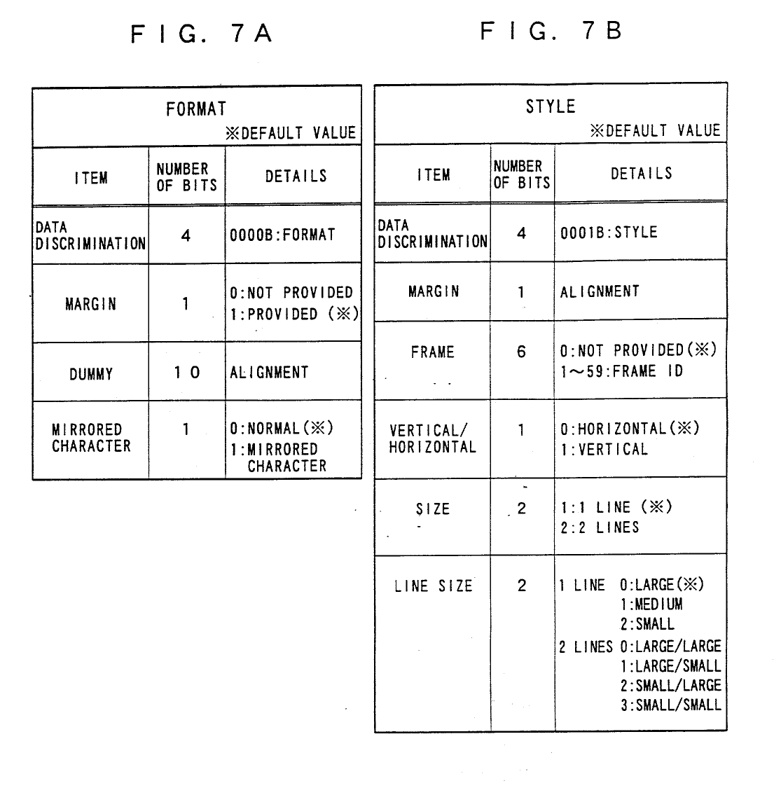

Among them, In [1]=“format” sets a value of a so-called “format”, and usually (in the case of a tape printing apparatus having a high functionality or the like) indicates a preset value of fixed printing (including fixed printing of a fixed format of any of files, FD, CD, video/audio tape, as well as fixed printing of a fixed length printing set as desired), a background pattern (pattern printed as a background), a margin (leading margin, trailing margin, automatically set to a wide, narrow, medium, other desired setting value), and so forth. In the illustrated example, the settings of these index values are limited to the functions of provision and non-provision of a margin, and application and non-application of mirrored character decoration (see FIG. 7A: However, the dummy data of 10 bits is provided, and hence the functions can be added as required.) Further, In [2]=“style” sets a value of a so-called style, and indicates provision and non-provision of a frame, vertical and horizontal (vertical writing/horizontal writing), a size (the number of lines, in the illustrated example), and so forth (see FIG. 7B). Although in the present embodiment, it is assumed that “format” and “style” can be only set to the whole document, this is not limitative, but similarly to “typeface” and “decoration”, they may be also set on a line-by-line basis.

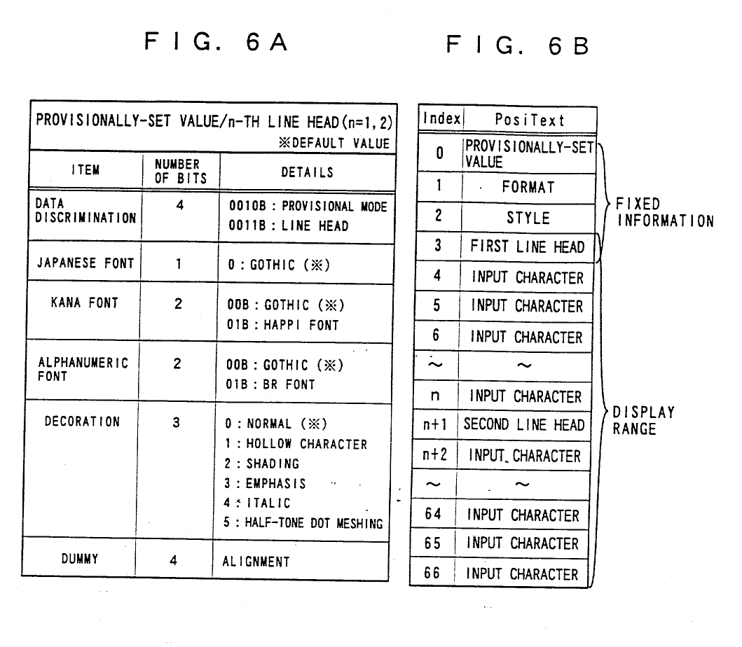

Next, a specification of In [0]=“provisional” and In [3]=“first line head” is defined as shown in FIG. 6A. The first four bits for “data discrimination” indicate whether a portion (data) with this index is in a provisional mode or sets a “line head”. More specifically, these four bits indicate whether the data indicate a “provisionally-set value” set to the whole document provisionally (as a default value), or a setting value for an individual line. The following five bits indicate a setting value of an option of “typeface”, and the three bits subsequent thereto indicated a setting value of so-called “decoration”. Further, these settings can be applied to the whole document as shown in FIG. 6B, as “the provisionally-set value”, and they can be applied separately to each line as “the n-th line head” (here, n=1 or 2).

In the state (T10) of FIG. 5B, the mark “1” in the form of a while character against a black square background indicates a line head mark of a first line, i.e. the aforementioned “first line head”, and in the following, a line head mark for a “n-th line head” is referred to as a “n-th line mark Hn (n=1, 2, . . . , in the present example, n is only equal to 1 or 2). Therefore, in an initial state in which no characters are entered, the first line mark H1 is displayed on the right side of the cursor K, as shown in the figure (T10).

In the tape printing apparatus 1, from this state (T10), when the user sequentially enters a character string of “ [symbol] ”, the text data of these letters are stored as (data structure) shown in FIG. 5C, and displayed as shown in FIG. 5D (T11). Further, from this state (T11), the user operates the left arrow key 330L (330UL), to thereby move the cursor K (relatively) to a position between “ [symbol] ” and “ [symbol] ” of “ [symbol] ” (i.e. to the right side of “ [symbol] ”, and then the selection key 323 is depressed for starting a new line, whereby the character string “ [symbol] ” subsequent thereto can be formed into the second line. In this case, in the data, In [6]=“2nd line head” is inserted as shown in FIG. 5E, and on the display, a second line mark H2 indicative of a line head of the second line is inserted as shown in FIG. 5F (T12).

This state (T12) is identical to the screen T22 shown in FIG. 8A, and as shown therein, whenever the user depressed the cursor key 330UL, the screen view is shifted to a state shown at a higher location as viewed in the figure, and whenever the user depresses the right arrow key 330R (cursor key 330DR), the screen view is shifted to a state shown at a lower location as viewed in the figure (T20 to T25). In these states, if the print key is depressed, a document which is formed of two lines, i.e. “ [symbol] ” on the first line and “ [symbol] ” on the second line, is printed, as shown in FIG. 8B, so that the user can produce a label G0 as shown in the figure.

Then, the method of setting “decoration” (character decoration) will be described. First, in the FIG. 8A state (T20 to T25), no settings have been made from the initial state (T10), and hence the default values in FIG. 6A have been set. That is, as “decoration”, the default value (in the illustrated example, “normal”: value providing no decoration) has been set.

From this state, i.e. in the state of a screen display allowing the text data to be edited (hereinafter referred to as “the text edit screen”), if the user depresses the mode key 329, the apparatus shifts to the setting mode for setting a typeface/style/character decoration, and displays a message notifying the fact is displayed for a predetermined time period (e.g. 0.75 seconds) (T30), immediately followed by displaying a first option “ [symbol] ” (typeface) (T31). It should be noted that in the tape printing apparatus 1, instructions input by key can be cancelled by the cancel key 326, and hence, by depressing the cancel key 326 from the above state (T30 to T31), the preceding state (T20) can be recovered (the operation of the cancel key 326 produces the same effects, unless otherwise specified, and hence description thereof will be omitted in the following description).

As options in a first hierarchical level of the setting mode, there are “ [symbol] ” (typeface) for setting typefaces of fonts, “ [symbol] ” (character decoration) for setting a character decoration”, and “ [symbol] ?” (end?) for terminating the present setting operation and returning to the text edit or other screen. The user can select a desired one of them by operating the cursor key 330 to cause it to be displayed in reverse video or in a flashing manner (illustrated as half-tone dot meshing), and depressing the selection key 323. Immediately after transition to each selection menu screen, the option selected (accessed) on the preceding setting operation at this level (in case, there is no such an option, one set to be selected by default) is displayed in reverse video, and when the user operates the cursor key 330 to select another, the selected option is displayed in a flashing manner since it is not the one selected on the preceding setting operation at this level. The option displayed in reverse video or in a flashing manner is an option to be finally selected by operation of the selection key 323, and hence the state of the option is referred to hereinafter as “displayed for selection”.

From the state (T31) in which the option “ [symbol] ” (typeface) is displayed for selection, whenever the user depresses the cursor key 330DR, the options “ [symbol] ” (typeface), “ [symbol] ” (character decoration), and “ [symbol] ?” (end?) are cyclically displayed for selection in the mentioned order. Inversely, whenever the cursor key 330UL is depressed, the above options are cyclically displayed for selection in the reverse order, i.e. in the order of “ [symbol] ” (typeface), “ [symbol] ?” (end?), “ [symbol] ” (character decoration). In the illustrated example, it is assumed that in the state of the “ [symbol] ” (character decoration) being displayed for selection, the selection key 323 is depressed (operated). From this selection, the screen shifts to a selection menu screen at a second hierarchical level, and as the option selected on the immediately preceding setting operation at this level (or selected by default), “ [symbol] ” (emphasis) is displayed (T33).

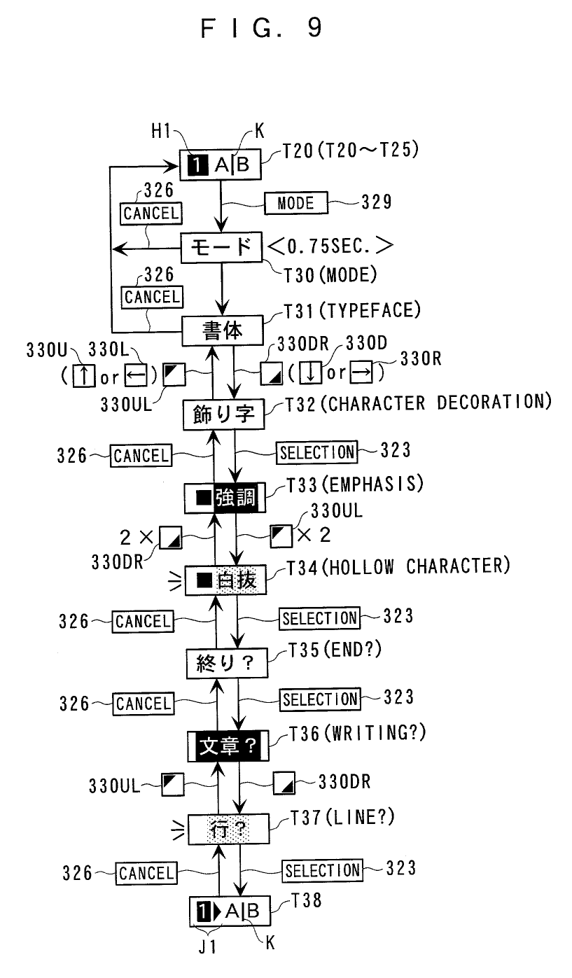

As the menu options at this second hierarchical level, as shown in the box of setting values for “decoration” in FIG. 6A, there are “ [symbol] ” (normal), “ [symbol] ” (hollow character), “ [symbol] ” (shading), “ [symbol] ” (emphasis), “ [symbol] ” (italic), and “ [symbol] ” (half-tone dot meshing). The user can select a desired one of them by operating the cursor key to display the same for selection. In the illustrated example, as shown in FIG. 9, if the selection key 323 is depressed with the option “ [symbol] ” (hollow character) being displayed for selection (T34), the option “ [symbol] ” (hollow character) is selected and the screen returns to the first hierarchical level, where the option “ [symbol] ?” (end?) is preferentially displayed (T35). From this state, further, the option “ [symbol] ” (typeface) may be selected to shift to a lower hierarchical level thereunder, and a desired typeface can be set. In the illustrated example, it is assumed that only settings for the “ [symbol] [symbol] ” (character decoration) are carried out, and hence the option “ [symbol] ?” (end?) is selected by depression of the selection key 323. If the user depresses the selection key 323 with the option “ [symbol] ?” (end?) being displayed for selection, the option “ [symbol] ?” (end?) is selected, and the screen shifts to a selection menu screen for selecting an object (range) to which the settings are applied (T36).

In this selection menu screen (T36), as menu options, there are “ [symbol] ?” (writing?) for applying the settings to the whole writing (document) and “ [symbol] ?” (line?) for applying the same to a desired line, and the user can select a desired one after displaying the same for selection. In the illustrated example, as shown in FIG. 9, in the state of the option “ [symbol] ?” (line?) being displayed for selection (T37), the user depresses the selection key 323, whereby the setting of “ [symbol] ” (line) is selected. In the present case, the setting operation in the setting mode is terminated at this time point, so that the screen shifts to the original text edit screen (T38). It should be noted that a line to which the character decoration is applied by selection of the above “ [symbol] ?” (line?) is one at which the cursor K was positioned on the text edit screen (T20 to T25) before the apparatus was switched to the setting mode. In the illustrated example, the character decoration is applied to the first line “ [symbol] ”.

Then, in the present embodiment, a line head mark at “the n-th line head” having the same value as “the provisionally-set value” of character decoration to be applied to the whole writing is designated by Hn (n=1, 2, . . . ; in the present example, n=1 or 2), as described above, and in the following, referred to the standard n-th line mark Hn. On the other hand, a line head mark at an “n-th line head” having a different value from the “provisionally-set value” of character decoration is referred to as an individual line mark and specifically designated by an individual n-th line mark Jn (n 32 1, 2, . . . : in the present example, n=1 or 2). Further, assuming that the standard first line mark H1 (see T20) is a line mark of “1” in the form of a hollow character against a black-filled square background, a new line mark is formed by adding a mark of right-oriented black-filled triangle to the right side of the standard first line mark H1 and compressing the whole combination of the two characters to the size of one character (compressed to ½ in the direction of width) and used for the individual first line mark J1 (see T38).

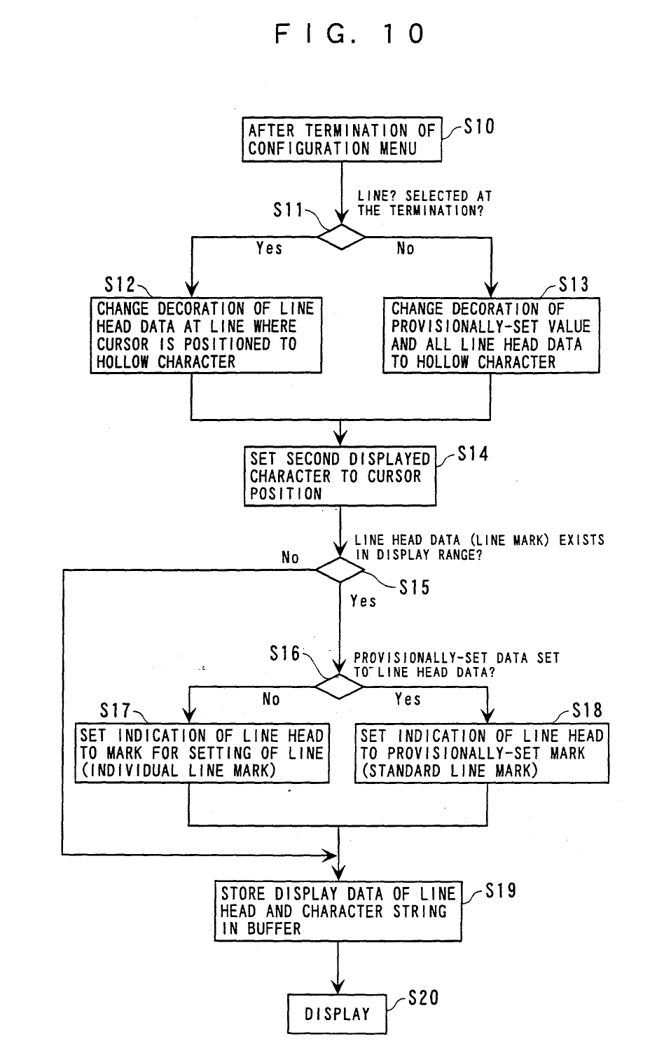

FIG. 10 shows a process performed after completing the setting of character decoration and the like in the setting mode and displaying the results of the character decoration on the display 4. In this process, first it is determined in a step S11 whether or not the “ [symbol] ?” (line?) is selected from the menu options of “ [symbol] ?” (line?) and “ [symbol] ?” (writing?). If the option “ [symbol] ?” (line?) has been selected (Yes to S11), the decoration of the line head data at the line at which the cursor K is positioned (the first line head data in the above example) is set to the value set in the setting mode. More specifically, in the above example, the setting value indicative of “ [symbol] ” (hollow character) is set to the decoration of the line head data (S12). On the other hand, if the option “ [symbol] ?” (writing?) has been selected, the setting value indicative of “ [symbol] ” (hollow character) is set to the provisionally-set value and the decoration of each item of all line head data.

Then, it is determined in a step S14 whether or not there is line head data within a range of display with respect to the position of the cursor K at a second character in position of display, i.e. whether or not a line mark should be displayed. If the line mark should be displayed (Yes to S15), it is determined in a step S16 whether or not provisionally-set value line head data holds, i.e. the line mark which should be displayed is the standard line mark. If an individual line mark should be displayed (No to S16), indication of a line head (line head indication) is set to an individual line mark for displaying the setting for the line (S17), and if the standard line mark should be displayed (Yes to S16), the line head indication is set to the standard line mark (S18). On the other hand, if there is no line head data within the display range (No to S15), the program proceeds without setting the line head indication.

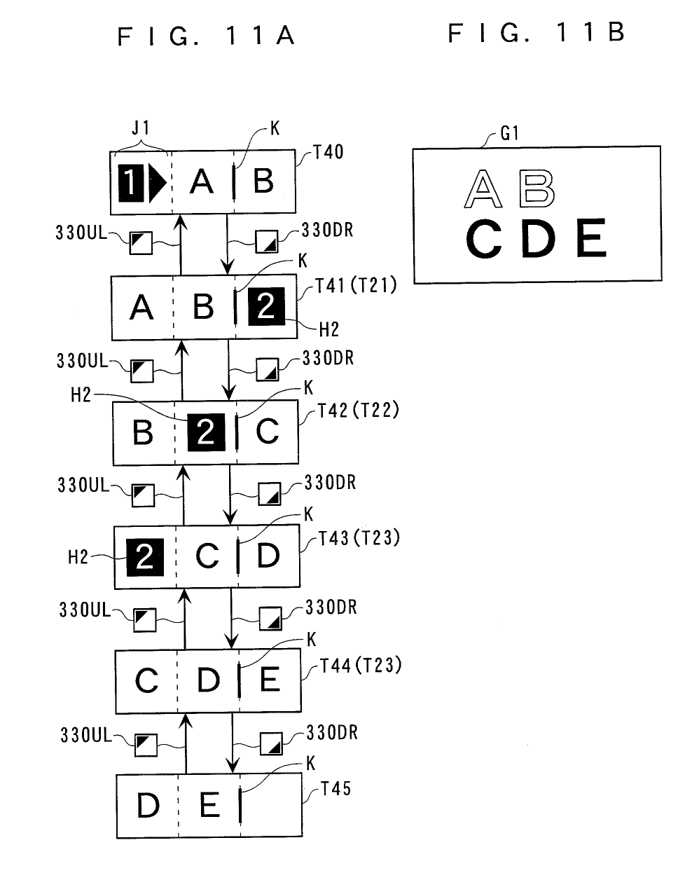

That is, after the above preparation is completed, display data of a line head and a character string on the line are formed according thereto (display image data is formed based on the text data), and stored in a display buffer (S19), whereby the display corresponding to the display data is carried out (S20). For example, 0in the above case, since the “ [symbol] ” (hollow character) is set to the first line, the individual first line mark J1 corresponding in size to one character is displayed (see T38 in FIG. 9, T40 in FIG. 11). If the application of character decoration to the whole document is set, the same display method as the preceding one is employed (see T20 in FIG. 9; T20 in FIG. 8).

For example, if from the state in which the whole document has been set to “ [symbol] ” (normal) in FIG. 8, if the character decoration of “ [symbol] ” (emphasis) is applied to the whole document, there is no difference in display, but the standard first line mark H1 and the standard second line mark H2 are used for display (however, when printed, the characters are emphasized by using thicker characters to effect the decoration of “ [symbol] ” (emphasis). Further, when the “ [symbol] ” (hollow character) is set only to the first line, as shown in FIG. 11A, the individual first line mark J1 and the standard second mark H2 are used for display, and when printed, the characters are printed as shown in FIG. 11B, whereby the illustrated label G1 can be formed.

As described above, in the tape printing apparatus of the present invention, first, basically, at least part of at least one line of a document whose character strings are arranged in respective lines can be displayed with a line mark added to each line. Therefore, even with a small-sized display screen, it is possible to grasp the position and the like of the displayed part with respect to the whole document. Further, character decoration can be set to the document on a line-by-line basis. Although there are a plurality of kinds of character decoration, a plurality of kinds of line marks corresponding to the kinds of character decoration (e.g. “standard line mark” and “individual line mark” in the above example) are provided, whereby by viewing a displayed line mark, the object (line) to be subjected to the character decoration and the kind of the character decoration can be easily grasped even with a small-sized display screen.

Further, the standard character decoration using the “provisionally-set value” can be set as the character decoration of the whole document, and the plurality of kinds of line marks includes a standard line mark indicating that the standard character decoration is set to the corresponding line. Therefore, even with a small-sized display screen, depending on whether the line mark is a standard line mark or not, it is possible to grasp whether each line is an object subjected to character decoration. When the document is composed of a plurality of lines, character decoration can be individually set to each line on a line-by-line basis, and the plurality of kinds of line marks include individual line marks each corresponding to character decoration set to an individual line, and hence from the kind of a line mark, it is possible to grasp the kind of character decoration of each line.

Further, the line marks include line number information indicative of a number assigned to a line to which the line mark is added, and hence from the display of the line number information, even with a small-sized display screen, it is easier to grasp the position of the displayed part in the whole document. Further, although each line mark contains the line number information of the line to which the line mark added, it can be displayed in a display area for one character, and hence, even with a small-sized display screen, it can be easily displayed. Further, the display of the information of the line number makes it even easier to grasp the position of the displayed portion in the whole document.

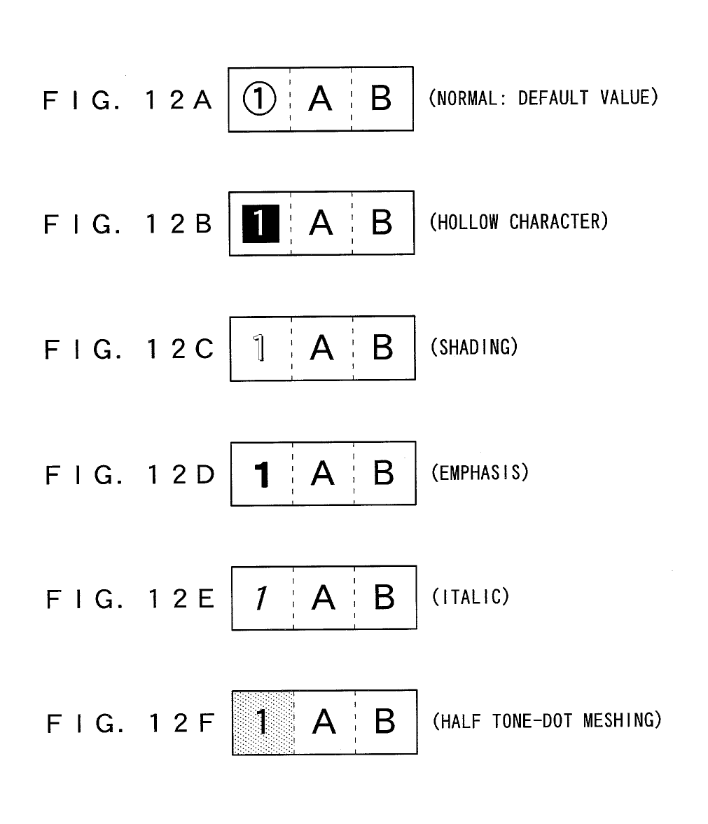

Although in the above example, as the plurality of kinds of line marks, the standard line mark indicative of the setting for the whole document and the individual line marks each indicative of the setting for an individual line are shown by way of example, this is not limitative, but e.g. as shown in FIGS. 12A to 12F, various different line marks associated with respective kinds of character decoration and particularly enabling the user to have an idea of the kind of character decoration may be provided to thereby enable a line mark to be used in a manner associated with the setting value (kind of character decoration). In this case, only a view of the line mark enables the user to have an idea of the character decoration represented thereby, and this makes it easier for the user to have an image of the printed document.

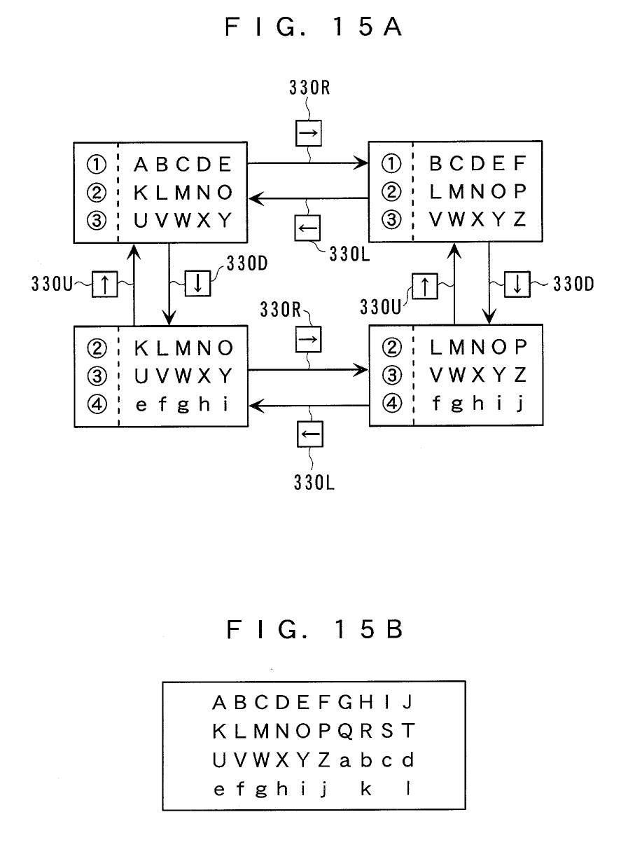

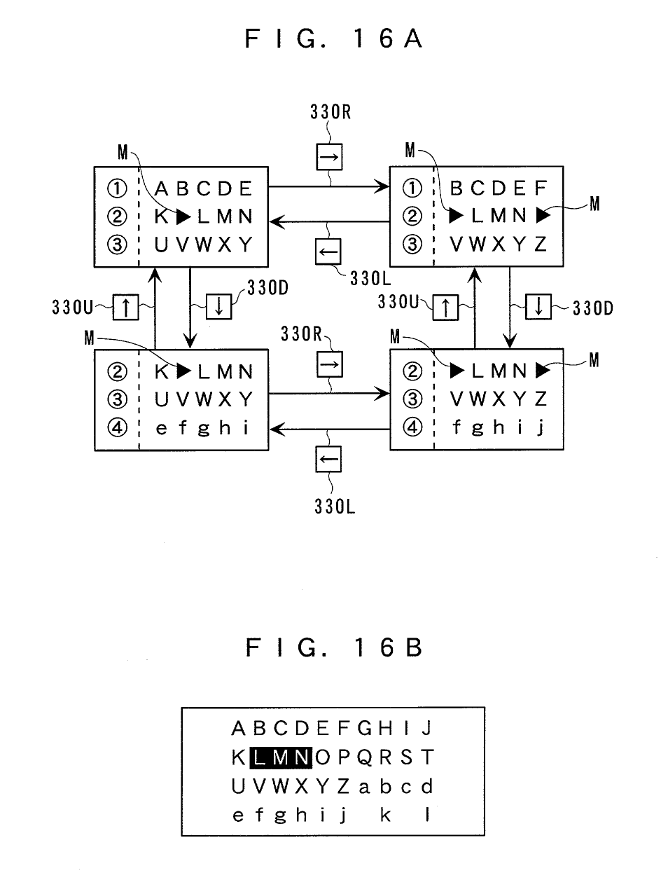

By the way, in the conventional method of display for an apparatus having a small-sized display screen, when character decoration is not provided, as shown in FIGS. 15A and 15B, the arrangement of character strings in a displayed image (see FIG. 15A) and the arrangement of the same in a print (see FIG. 15B) agree with each other. However, if character decoration is applied to part of the character strings, there are employed special techniques of displaying the settings, e.g. the technique of sandwiching a character string subjected to character decoration between two marks of a predetermined symbol M (character decoration mark) for display, and the technique of indicating a starting end or a changing end of a range of character decoration by the character decoration mark M. Therefore, the arrangement of the character strings in a displayed image (see FIG. 16A) and the arrangement of character strings in a print (see FIG. 16B) do not agree with each other (the displayed position of “ [symbol] ” on the second line is displaced from the originally-aligned corresponding characters on the other lines). This makes it difficult to grasp an image of the arrangement of characters as an actual result of edit (to be reflected on the print) at the time of the edit through the displayed image.

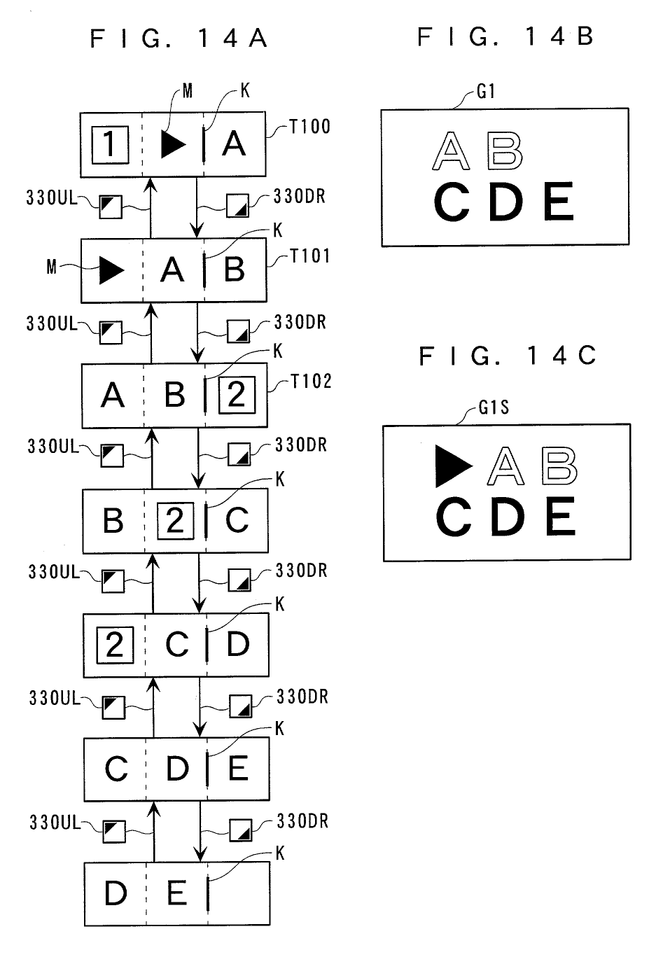

This is also basically true for the case in which one line (of three characters) is displayed as in the above embodiment, and when a label G1 is to be produced by printing as shown in FIG. 14B (identical to the one shown in FIG. 11B), the corresponding portion displayed during the edit (see FIG. 14A) appears as if the label G1S shown in FIG. 14C were to be formed by printing.

In the present method of display according to the present embodiment, basically in the same manner as in the prior art, immediately before a decoration start character “ [symbol] ” on the first line, in the example described above) at a starting end of the character decoration, an individual line mark (playing the role of the character decoration start mark) is arranged. This makes it easier to grasp an object to be subjected to the character decoration even with a small-sized display screen. Further, since line marks respectively associated with lines (containing line number information in the above embodiment) are added, it is easier for the user to grasp the position of the displayed portion in the whole document.

Further, when the decoration start character “ [symbol] ” is a character at the head of the line, instead of the line mark, a synthesis line mark formed by synthesizing the line mark (hollow character against a black-filled square background) and the decoration start character (right-oriented black-filled triangle, i.e. the character decoration mark appearing in FIG. 14A and FIG. 16A) are provided (by newly forming the same or selecting from data prepared in advance and stored) and arranged to omit the character decoration mark M, so that as shown in FIG. 11A corresponding to FIG. 14A, the displayable range of the document can be increased even when the display screen having the same size as that of the prior art is used. Further, since the synthesized mark formed by combining or synthesizing the character decoration start mark M with a line mark is arranged, there is no displacement of characters caused by provision of the character decoration start mark M, so that the user can easily grasp the position of characters.

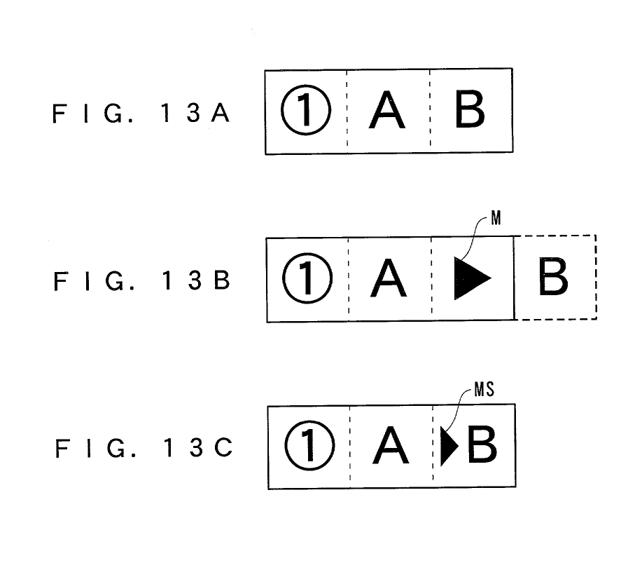

Although in the above example, description is given only of the case in which character decoration is applied on a line-by-line basic, this is not limitative, but as shown in FIGS. 13A to 13C, when character decoration is applied starting with a character at an intermediate position in a line of an original character string (see FIG. 13A), instead of the conventional method the result of which is shown in FIG. 13B, as shown in FIG. 13C, a synthesized character formed by synthesizing a character decoration start mark and a decoration start character and corresponding in size to one character is provided (by newly forming the same or selecting from data prepared in advance and stored) for display, whereby the displayable range of the document can be increased even when the display screen having the same size is used. In this case as well, the advantages of the prior art are preserved, i.e. an object subjected to character decoration can be easily grasped even with a small-sized display screen, since a character decoration start mark is arranged before a decoration start character at a staring end of character decoration. Further, the present invention provides the advantageous effects of no displacement of character arrangement which has been conventionally caused by provision of the character decoration start mark, which makes it easier for the user to grasp the position of each character.

Further, although in the above embodiment, description is given of the thermal-type tape printing apparatus, this is not limitative, but the invention can be also applied to an ink jet-type tape printing apparatus. Further, the invention can be also applied to other types of the printing apparatus or other apparatuses and devices, so long as they process a document on the same condition, i.e. by using a small-sized display screen.

It is further understood by those skilled in the art that the foregoing are preferred embodiments of the invention, and that various changes and modification may be made without departing from the spirit and scope thereof.

What is claimed is:

1. A document display method for displaying at least part of a document in which a plurality of characters are arranged,
the document display method comprising the step of:
making available a synthesis character formed by synthesizing a character decoration start mark indicative of a character decoration starting end as a starting end or a changing end of character decoration set to a portion of the document, and a decoration start character which is a character at the character decoration starting end of the portion to which the character decoration is set; and
displaying the synthesis character in place of two characters of the character decoration start mark and the decoration start character, when the at least part of the document includes the decoration start character.

2. A document display method for displaying at least part of a document in which a plurality of characters are arranged, with a line mark added to each of at least one line formed by the plurality of characters,
the document display method comprising the steps of:
making available a synthesis line mark formed by synthesizing the line mark and a character decoration start mark indicative of a starting end of character decoration set to a portion of the document, when a character at the starting end of the character decoration is a start character at a start of one of the at least one line; and
displaying the synthesis line mark in place of the line mark, while omitting the character decoration start mark.

3. A document display method according to claim 2, wherein the at least one line is displayed in a line, and the line mark and the synthesis line mark each play a role of a mark indicative of a position where a new line is started.

4. A document display method according to claim 2, wherein the line mark and the synthesis line mark each represents a line number of the line associated therewith.

5. A document display apparatus for displaying at least part of a document in which a plurality of characters are arranged,
the document display apparatus comprising:
synthesis character-forming means for forming a synthesis character by synthesizing a character decoration start mark indicative of a character decoration starting end as a starting end or a changing end of character decoration set to a portion of the document, and a decoration start character which is a character at the character decoration starting end of the portion to which the character decoration is set; and
display means for displaying the synthesis character in place of two characters of the character decoration start mark and the decoration start character, when the at least part of the document includes the decoration start character.

6. A document display apparatus for displaying at least part of a document in which a plurality of characters are arranged,
the document display apparatus comprising:
synthesis character-storing means for storing synthesis characters each formed by synthesizing a character decoration start mark indicative of a character decoration starting end as a starting end or a changing end of character decoration set to a portion of the document, and one of a plurality of characters each of which can be a decoration start character as a character at the character decoration starting end of the portion to which the character decoration is set; and
display means for displaying the synthesis character in place of two characters of the character decoration start mark and the decoration start character, when the at least part of the document includes the decoration start character.

7. A document display apparatus for displaying at least part of a document in which a plurality of characters are arranged, with a line mark added to each of at least one line formed by the plurality of characters,
the document display apparatus comprising:
synthesis line mark-forming means for forming a synthesis line mark by synthesizing the line mark and a character decoration start mark indicative of a starting end of character decoration set to a portion of the document, when a character at the starting end of the character decoration is a start character at a start of one of the at least one line; and
display means for displaying the synthesis line mark in place of the line mark, while omitting the character decoration start mark.

8. A document display apparatus according to claim 7, wherein the at least one line is displayed in a line, and the line mark and the synthesis line mark each play a role of a mark indicative of a position where a new line is started.

9. A document display apparatus according to claim 7, wherein the line mark and the synthesis line mark each represents a line number of the line associated therewith.

10. A document display apparatus for displaying at least part of a document in which a plurality of characters are arranged, with a line mark added to each of at least one line formed by the plurality of characters,
the document display apparatus comprising:
decoration line mark-storing means for storing a decoration line mark corresponding to the line mark; and
display means for displaying the decoration line mark in place of the line mark, when a character at the starting end of character decoration set to a portion of the document is a start character at a start of one of the at least one line.

11. A document display apparatus according to claim 10, wherein the at least one line is displayed in a line, and the line mark and the synthesis line mark each play a role of a mark indicative of a position where a new line is started.

12. A document display method according to claim 10, wherein the line mark and the synthesis line mark each represents a line number of the line associated therewith.
